(19) United States
(12) Patent Application Publication
(10) Pub. No.: US 2014/0081686 A1
(43) Pub. Date: Mar. 20, 2014

(54) SYSTEMS AND METHODS OF KNOWLEDGE TRANSFER

(71) Applicants: Sanjaya G. Hariharan, Bangalore (IN); Ashish I. Chitkara, Bangalore (IN)

(72) Inventors: Sanjaya G. Hariharan, Bangalore (IN); Ashish I. Chitkara, Bangalore (IN)

(21) Appl. No.: 14/116,159

(22) PCT Filed: Jul. 31, 2011
(86) PCT No.: PCT/US11/46062

§ 371 Date: Nov. 7, 2013

(51) Int. Cl. G06Q 10/06

(52) U.S. Cl. CPC G06Q 10/0631
USPC 705/7.12

(57) ABSTRACT

Automating provider transitions is disclosed. An example method includes identifying groups in an infrastructure and corresponding information for each of the groups. The method also includes correlating information for each of the groups with predetermined objectives of a knowledge transfer. The method also includes generating reports based on the correlated information, the reports providing documentation of customer installations.

### BACKGROUND

The client/server computing environment continues to expand in business services, with the latest iteration of supported programmatic access to services and data being offered by many different providers. As the various information technology (IT) infrastructures have both grown in capability and functionality, the number of IT service providers have also grown and become more sophisticated, now competing for a wide variety of these types of services, including maintaining, managing and supporting software applications for customers.

In the IT services market, “transitions” are the bridge between a customer's current-state IT operating model, and a future-state operation, often outsourced to a supplier such as an Enterprise Services Provider (ESP). Transition is about change, and comes with risk. As incoming teams overlap with outgoing teams, transitions also come with so-called “bubble” costs that temporarily increase spending for the customer. Therefore, customers prefer short and efficient transitions. Longer transition times can make proposals uncompetitive.

Customers are becoming increasingly aware of transition risk and desire to carefully manage change within their organization. Customers expect vendors to be focused, not only on risk, but on being culturally aligned, building strong relationships, and managing transitions. The combined challenge of cost-control, yet increasing time spent on the relationship, delivering value and increasing visibility of the vendor to the customer, are all factors in being able to offer competitive proposals.

### BRIEF DESCRIPTION OF THE DRAWINGS

FIG. 1 is a high-level block diagram of an example networked computer system which may be implemented for knowledge transfer.

FIG. 2 shows an example architecture of machine readable instructions, which may execute program code for knowledge transfer.

FIG. 3 shows example interfaces 300, 310, and 320 which may be implemented for knowledge transfer.

FIGS. 4a-e show example interfaces illustrating sales and distribution reports which may be generated for knowledge transfer.

FIG. 5 is a flowchart illustrating example operations which may be implemented for knowledge transfer.

### DETAILED DESCRIPTION

The transition from one vendor to another may involve a significant amount of knowledge transfer. Knowledge transfer is the process of informing an incoming service provider of a customer's infrastructure so that the incoming service provider can meet or exceed the customer's requirements. Customers are increasingly aware of transition risk when switching service providers, and therefore seek vendors that are collaborative and align well culturally within the customer's infrastructure. But manual knowledge transfer often involves in-person interviews and other labor-intensive data collection processes, and therefore comes at a high cost for both the vendor and the customer.

While service providers strive to provide strong customer-relation and collaboration processes during the transition, augmenting these processes with automated tooling can reduce costs of manual knowledge transfer, and make collaboration and thought leadership more visible to the customer. These systems and methods can help retain and further strengthen the service provider's position in the market by institutionalizing and aiding collaboration with the customer, while leveraging the customer's existing infrastructure.

An example system for knowledge transfer described herein may be implemented to at least partially automate transitions. The system includes a non-transient computer readable medium to store machine-readable instructions, and a processor which executes the machine-readable instructions. The system may identify groups in an infrastructure. Groups may include, but are not limited to, workgroups, divisions, and project-based groups, such as sales and distribution, materials managements, financial and control, and project planning. In addition to infrastructure groups, other types of groups may include enterprise resources such as, but not limited to master data, functionalities, and process flow.

The system may further correlate information for each of the groups with predetermined objectives of a knowledge transfer. Correlating data may include examining information for the groups, such as, a customer's infrastructure (e.g., hardware and/or software), and various functional components within the customer's infrastructure (e.g., invoicing modules, and inventory management modules), in addition to other processes and controls (e.g., chain of command within the organization).

The system may also generate documentation of existing and proposed customer installations for the infrastructure. Again, documentation may also be generated for other enterprise resources such as, but not limited to master data, functionalities, and process flow. Reports may include documentation for sales and distribution, materials management, financial and control, and/or project planning. It is noted that these modules are examples only, and other modules now known or later developed may also be used with the system described herein. The documentation may provide information and instruction for efficient knowledge transfer between a departing service provider and an incoming service provider, without the incoming service provider having to manually interview personnel and interrogate the various (and potentially numerous) systems and processes being utilized by the customer.

In the example market context of IT service providers, the systems and methods described herein address existing challenges in knowledge transfer. The service provider can reduce the duration of transitions, also reducing costs, by implementing tooling that automates knowledge-transfer. The service provider can further automate other processes, such as project management, establishing and building relationships with the customer, and understanding governance, so that the service provider and the customer can collaborate in ways which have previously been difficult to institutionalize.

Before continuing, it is noted that as used herein, the terms “include” and “including” mean, but is not limited to, “include” or “including” in addition to “includes at least” or “including at least.” The term “based on” means “based on” in addition to “based at least in part on.”

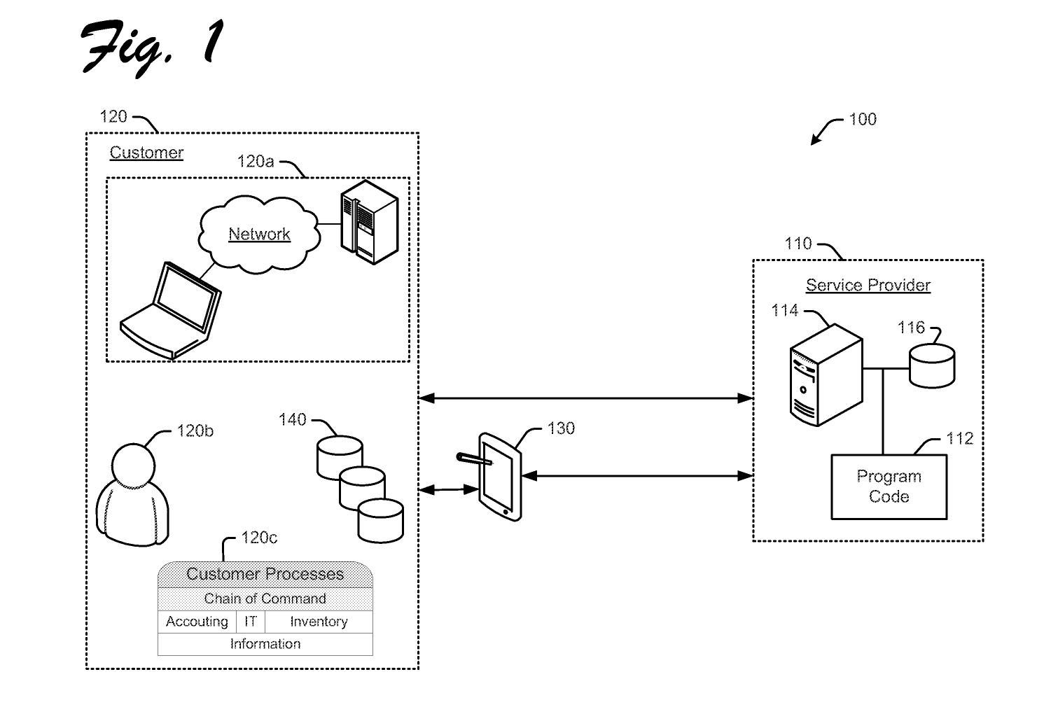

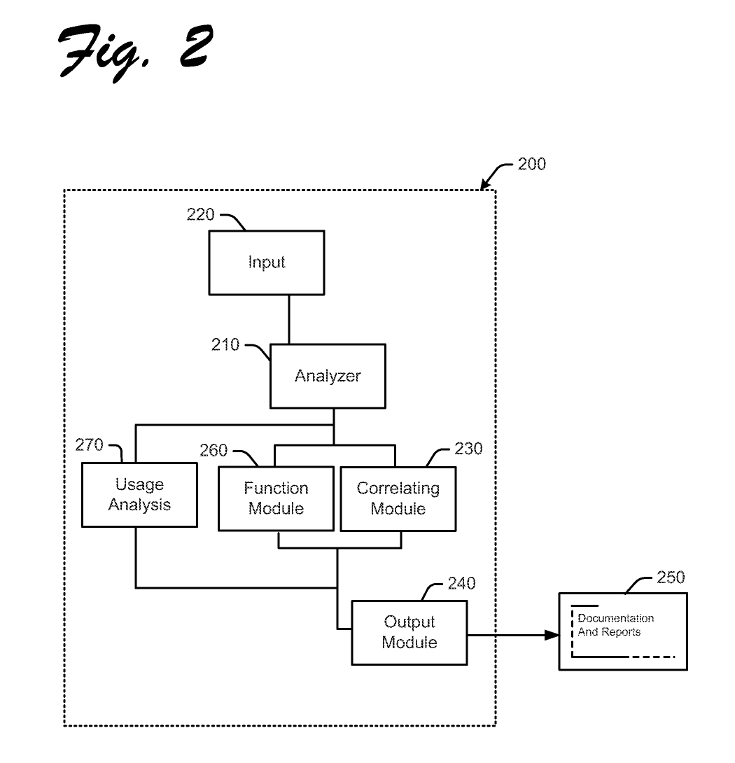

FIG. 1 is a high-level block diagram of an example networked computer system which may be implemented for knowledge transfer. System 100 may be implemented by the service provider 110 with any of a wide variety of computing devices, such as, but not limited to, stand-alone desktop/laptop/netbook computers, workstations, server computers, blade servers, mobile devices, and appliances (e.g., devices dedicated to providing a service), to name only a few examples. Each of the computing devices may include memory, storage, and a degree of data processing capability at least sufficient to manage a communications connection either directly with one another or indirectly (e.g., via a network). At least one of the computing devices is also configured with sufficient processing capability to execute the program code described herein.

In an example, the service provider 110 may provide, or offer to provide, a service for a customer 120. For purposes of illustration, the service provider 110 may provide IT management services. Other services may also be provided. The customer 120 may already be receiving these same or similar services, either provided in-house by the customer 120 or outsourced to a different service provider 110. In other examples, the customer 120 may be seeking a new service, or seeking to have the service provider 110 provide new services to the customer's existing services.

Bringing the service provider 110 on board involves at least some transition. The transition involves at least some degree of knowledge transfer, so that the service provider 110 can understand the customer's existing infrastructure, and so the service provider 110 can take over at least some of the services already being provided for the customer 120 and/or change services and/or provide new services for the customer 120.

The knowledge transfer involves learning about the customer's existing infrastructure. The customer's infrastructure may include hardware infrastructure 120a, including computers and networks, human resource infrastructure 120b, and institutional infrastructure 120c (e.g., customer processes, chain of command, infrastructure, and other information). The knowledge involves “Functional” and “Business Process” knowledge and its usage at a client environment as built into Enterprise Resource Planning (ERP) Software inside the client environment. Infrastructure may include general purpose computing services, application programming interfaces (APIs) and related support infrastructure, application engines (e.g., inventory management systems), and hosted business services (e.g., accounting systems).

The knowledge transfer may be at least partially automated, for example, using program code 112 executed by the service provider 110 within put from the customer 120. In an example, the program code may be executed on a host configured as a server computer 114 with computer-readable storage 116. In an example, the program code 112 may be implemented to gather information about a customer's infrastructure.

The host 114 may be any suitable computer or computing device capable of accessing the information about the customer's infrastructure. Host 114 is not limited to any particular type of device(s). In some instances (e.g., where the service provider 110 uses computing devices such as a tablet or mobile phone), at least part of the program code 112 may be better performed on a separate computer system having more processing capability, such as a personal computer or server computer, or even a plurality of server computers on a local area network.

For purposes of illustration, the service provider 110 may deploy personnel to the customer's site to gather at least some of the information about the customer's infrastructure using mobile computing devices 130 having interfaces to the program code 112. But the information may be transmitted or offloaded to a computing system with more processing and analysis capability. For example, the service provider 110 may implement a cloud-based service, wherein the program code 112 is executed on at least one computing device local to the customer site, but having access to the program code 112 in the cloud computing environment.

Before continuing, it is noted that the computing devices described herein are not limited in function. The computing devices may also provide other services in the system 100. For example, host 110 may also provide transaction processing services and email services for the client 120.

The program code 112 may have direct and/or indirect access to information about the customer's infrastructure. That is, the customer 120 may provide databases including some of the information. Other information may be obtained directly by electronically “crawling” the customer's infrastructure and accessing data directly with limited or no human interaction. The sources 140 of information may be part of the customer's infrastructure, or maintained separately. In addition, the sources 140 of information may be physically distributed in one or more network and/or customer networks.

The sources 140 of information may include data files, databases, and other data structures, for maintaining information, applications for providing application data, computing resources for providing processing, and storage resources for providing storage facilities, to name only a few examples of information sources as part of the customer's infrastructure. There is no limit to the type or amount of information that may be provided by the sources 140. In addition, the information may include unprocessed or “raw” data, or the content may undergo at least some level of processing. The program code 112 “crawls” and “mines” the information in sources 140.

As mentioned above, the program code 112 may be executed by any suitable computing device. In addition, the program code may be used to serve one or more than one customer 120. The information provided to the program code 112 may be difficult and time consuming to manually extract from the customer 120, particularly when the customer's infrastructure is dynamic and has changed over time through multiple iterations of the customer's personnel. However, the program code 112 may be used to quickly and efficiently capture knowledge specific to the customer's infrastructure, including but not limited to, hardware, software, and other systems and processes. The program code may further be used to provide documentation for a customer 120 and/or instruction for efficient knowledge transfer between a departing service provider and an incoming service provider. The output of program code 112 may also be used to better refine and shorten the transition plan for actually executing the transition and better predict the need and availability of the customer Subject Matter Experts (SME) required to provide knowledge to the incoming service provider staff.

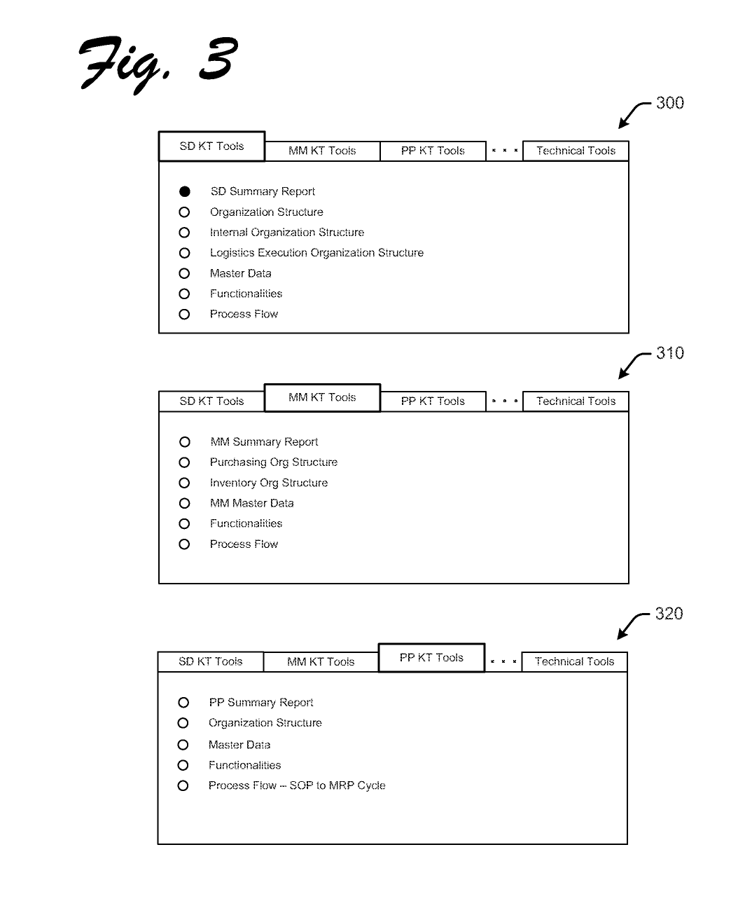

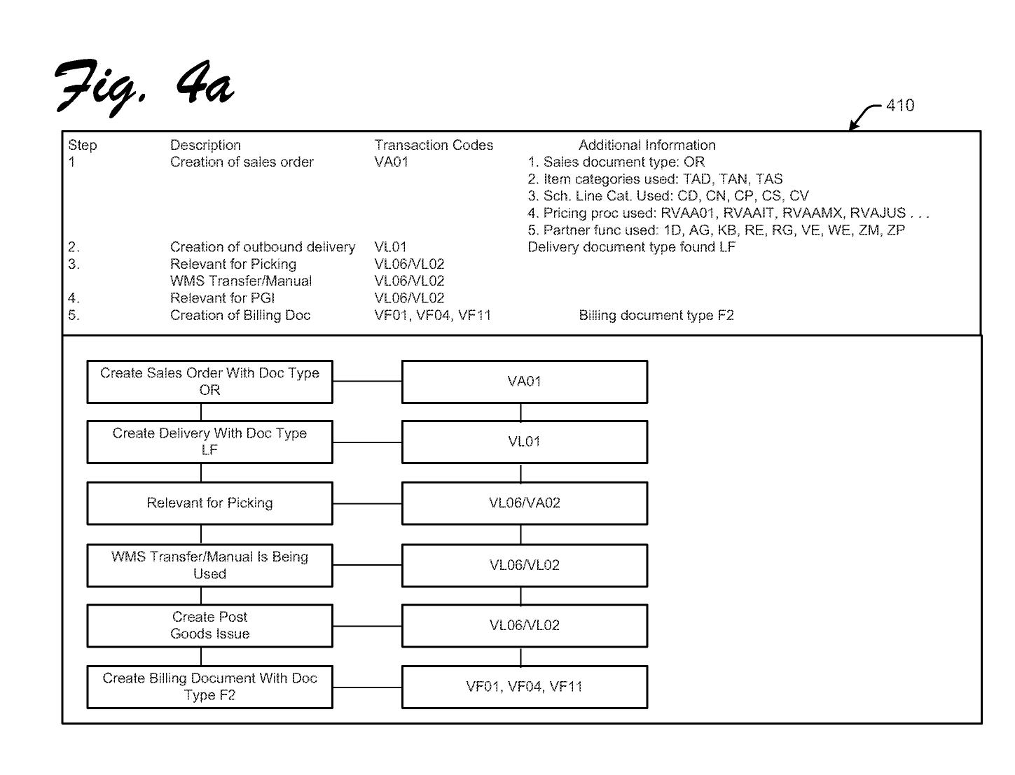

The program code 112 can be better understood with reference to FIG. 2 and the following discussion of various example functions. However, the operations described herein are not limited to any specific implementation with any particular type of program code.

FIG. 2 shows an example architecture 200 of machine readable instructions, which may be executed at the start of a knowledge transfer. In an example, the program code 112 discussed above with reference to FIG. 1 may be implemented in machine-readable instructions (such as, but not limited to, software or firmware). The machine-readable instructions may be stored on a non-transient computer readable medium and are executable by one or more processor to perform the operations described herein. It is noted, however, that the components shown in FIG. 2 are provided only for purposes of illustration of an example operating environment, and are not intended to limit implementation to any particular system.

The program code executes the function of the architecture of machine readable instructions as self-contained modules. These modules can be integrated within a self-standing tool or “tooling,” or may be implemented as agents that run on top of an existing program code. Such tooling automates efficient and accurate knowledge extraction from complex infrastructure, thereby reducing client subject matter expert (SME) involvement, transition timeframes, and associated overall price.

In an example, the architecture of machine readable instructions may include an analyzer module 210. The analyzer module 210 may cooperate with an input module 220. The input module 220 may be implemented to discover or identify groups in an infrastructure. The analyzer module 210 may also cooperate with a correlating module 230. The correlating module 230 may be implemented to correlate information for each of the groups with predetermined objectives of a knowledge transfer. An output module 240 may construct data records and reports, for example, in the form of documentation 250 of existing and proposed customer installations for the infrastructure.

A usage analysis module 270 may also be provided. The usage analysis module 270 may analyze usage data, including, but not limited to, usage of functions, customizations, and templates (e.g., a purchase order template).

The analyzer module 210 may analyze current data, historical or archived data, and/or a combination thereof (e.g., provided by the input module 220). Data analyzed by the analyzer module 210 may include information related to the customer's infrastructure. An ERP platform provides capability for enterprises to manage financial, production, and operations data, including accounting, inventory, personnel, physical plants, management and process flows, e-business applications, customer management, and supplier/vendor management, to name only a few examples. The ERP platform may include a number of functional cells to carry out operations for providing these capabilities. Some or all of the functional cells may be activated for a particular customer. In addition, various functional cells may also be customized for a particular customer's enterprise.

The analyzer module 210 may cooperate with the input module 220 to request and/or retrieve data about, generated by, or otherwise associated with the ERP functional cells. This data may be used to analyze the customer's infrastructure. The data may be analyzed at a level such that suitable analysis and correlation algorithms may be implemented to carry out the desired knowledge transfer. This analysis and correlation may be based at least in part on heuristic techniques for correlating information with predetermined objectives of a particular knowledge transfer.

The analyzer module 210 may also cooperate with the output module 240 to generate documentation 250 of existing and proposed customer installations for the infrastructure. For purposes of illustration, the documentation may include master data reports, process flow reports (e.g., describing workflow processes), and function reports (e.g., describing usage information, including frequency of use). At a more granular level, the documentation may include sales and distribution reports, materials management reports, financial and control reports, and project planning reports. Other example reports may also be generated.

Enterprises may install, upgrade, and change infrastructure over time. This is typically accomplished by multiple vendors and/or personnel, particularly for larger enterprises. Often, the customer does not even have a complete set of documentation for the infrastructure of an entire enterprise. Thus, in addition to providing the service provider with an automated knowledge transfer, which can be utilized by the service provider to ease transitions and provide the customer with desired services, the documentation generated by the output module 240 may also provide the customer with more complete documentation for the enterprise infrastructure. The documentation may also be updated over time, and reusable, by the service provider and/or by the customer.

In another example, the analyzer module 210 may also cooperate with a function module 260. The function module 260 may identify functions which have been activated in the SAP platform for the customer's infrastructure.

For example, an enterprise may have many (e.g., hundreds) of functions available in the ERP platform. Not all of these functions may be activated. Some of the activated functions may not be in use by the customer, or may only be used infrequently. The knowledge transfer can be enhanced by focusing only on activated functions. The knowledge transfer can be further enhanced by focusing the transition only on activated functions which are used more frequently (e.g., as determined by a threshold set by the customer and/or the service provider).

The function module 260 may also identify custom versus standard functions. For example, the ERP deployment for a particular customer may include standard (e.g., so-called “out of the box”) functions, in addition to customized function(s). The knowledge transfer can be enhanced by focusing the transition on customized functions. For example, the service provider may build on, or modify, or add custom functions for the customer, instead of spending time analyzing standard modules.

To illustrate, the analyzer module 210 may discover that a customer has ten different purchase order (PO) templates. Based on actual transaction data, the analyzer module 210 may determine that one of the purchase order templates is used 70% of the time, and another purchase order template is used 25% of the time. Accordingly, the service provide can focus the knowledge transfer on the two PO templates that are used 95% of the time. Accordingly, the service provider saves time during the knowledge transfer by not having to learn about all ten templates. It is apparent that when multiplied across a large enterprise, the time and associated cost savings can be significant.

Automating knowledge transfer as described above may be used to reduce the cost and/or duration of knowledge transfer, for example, when a service provider is submitting a proposal, or has already been awarded a proposal to provide services for a customer. The tools provide an effective and accurate knowledge capture of existing infrastructure that can be used to estimate cost and tailor proposals. The customer's involvement in the transition can be reduced and focused on more important aspects, and freeing other resources for ongoing operations. These and other aspects may be further understood with reference to the following examples.

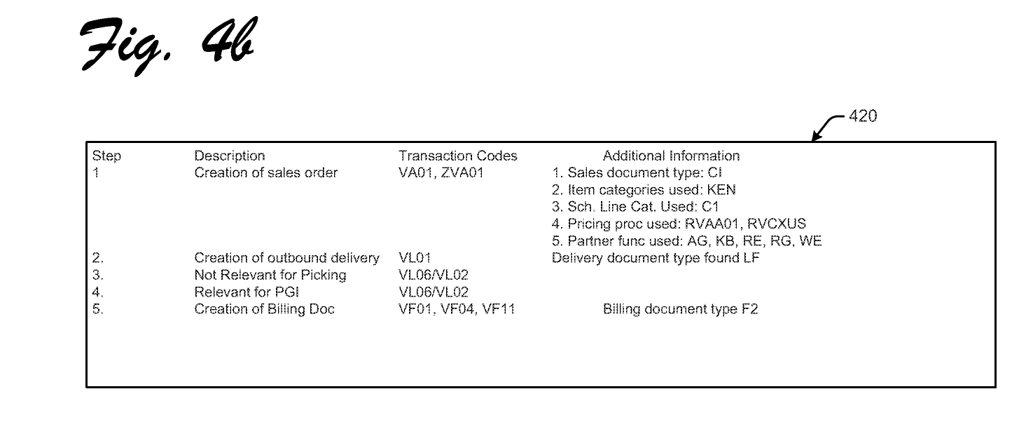

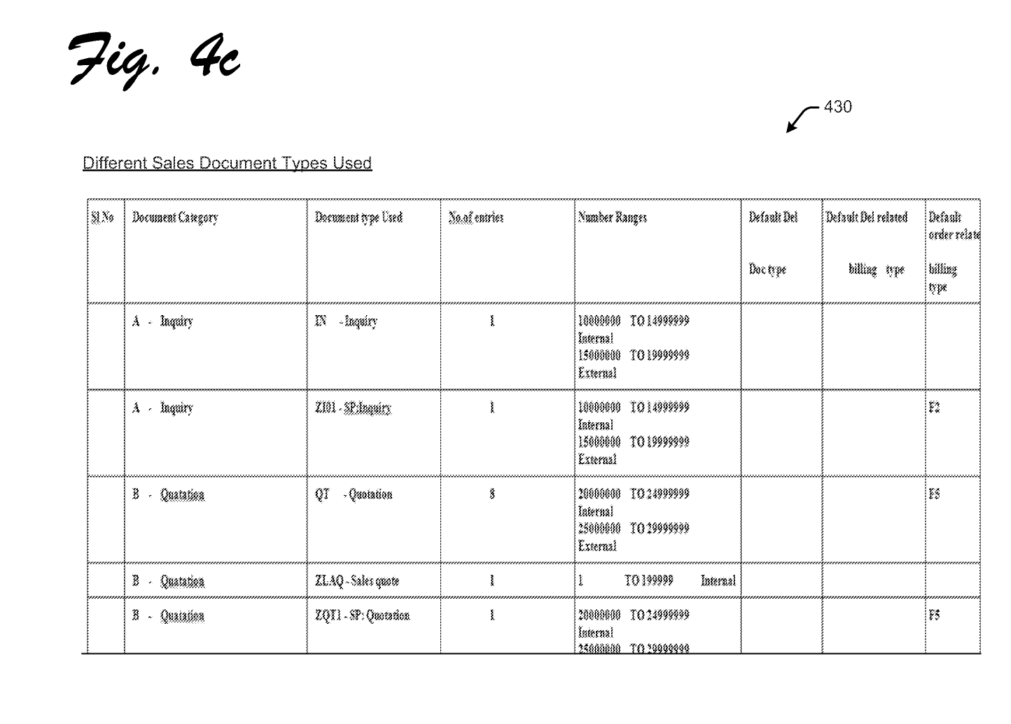

FIG. 3 shows example interfaces 300, 310, and 320 which may be implemented for knowledge transfer. An example of the program code may be implemented as a Knowledge-Transfer (KT) Accelerators. The interfaces may include several tabs for providing user interaction, for both inputting and outputting information related to a knowledge transfer. In this example, a sales/distribution (SD) interface 300, a materials management (MM) interface 310, and a project planning (PP) interface 320 for an SAP platform are shown, although other functionality may also be supported.

In an example where the user selects the SD module, information may be grouped into (a) Organization Structure, (b) Master Data/Functionalities, and (c) Business Process Flow. A business process flow report may be generated by the KT accelerator. The report may include details of specific custom transactions (referred to as “Z programs” in SAP).

The KT Accelerators may be implemented as pre-built software that crawls and extracts information on a customer's Enterprise Resource Planning (ERP) environment, thereby reducing conventional knowledge-transfer timelines. For example, in an SAP context, the input module described above may mine the implementation landscape, correlate various tables, look for anomalies and customizations, and correlates this data to generate various documentation. As such, the KT Accelerators reduce or altogether eliminate the error prone and inefficient in-person interviews. In some examples, the KT Accelerators may eliminate 3-4 weeks, or more, of manual processes, thus reducing the associated labor cost during transitions, but moreover, can be used to build accurate documentation for customers.

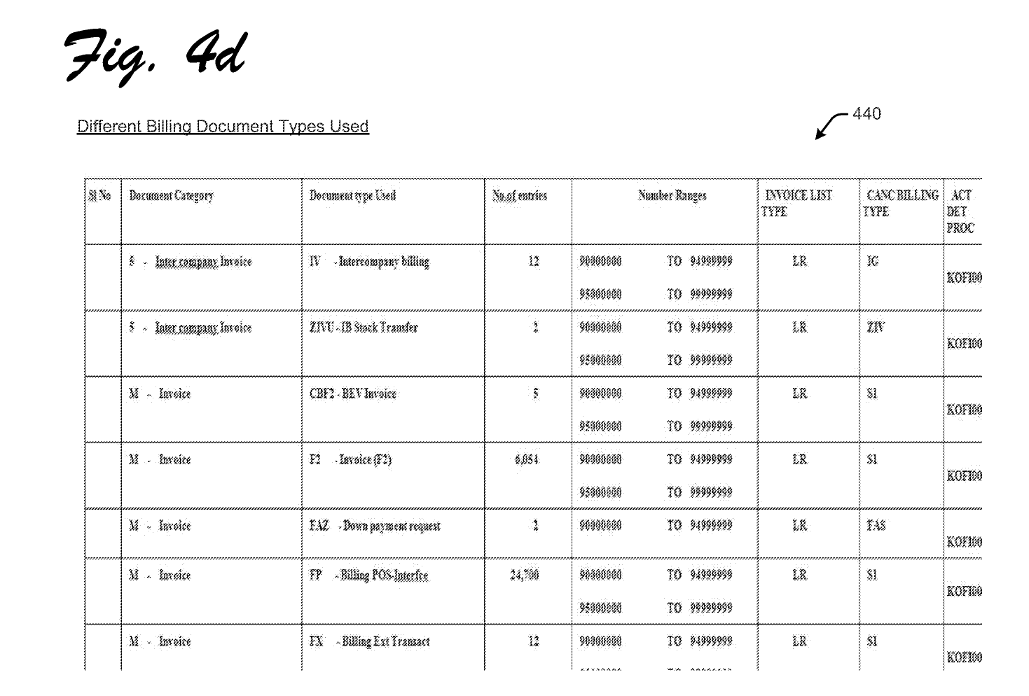

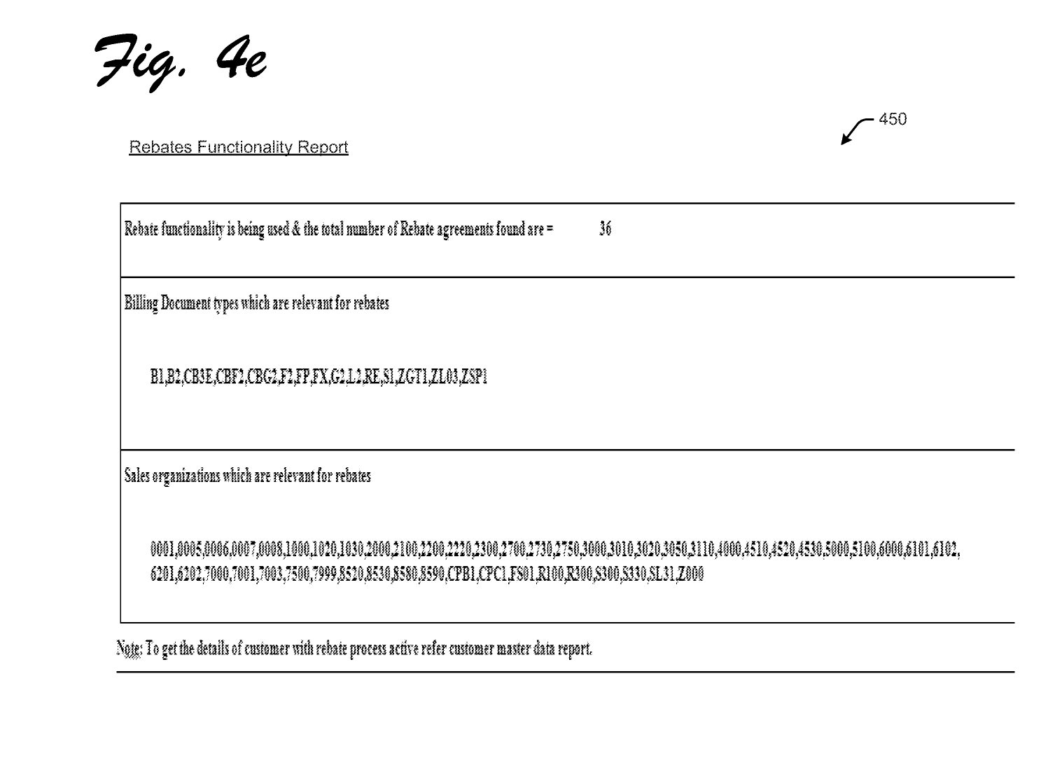

FIGS. 4a-e show example interfaces illustrating sales and distribution reports which may be generated for knowledge transfer. In this example, the reports are generated using the KT Accelerator with an SAP platform. The reports are provided only for purposes of illustration, however, and are not intended to be limiting.

FIG. 4a shows an example report 410 for a sales document flow overview. In this example, the tool displays complete business process flows for different scenarios which are being used by the customer. The report displays the business process flow for different sales document types, which can be categorized based on document category, such as sales orders, scheduling agreements, contracts, return orders, debits, and credits.

The report 410 shows different steps involved in a business process, such as the creation of a sales order, delivery, pickup, Post Goods Issue, and billing. The report 410 also shows T-codes used to create the step, and inputs used to create the step. Sales document type used, item categories used, and pricing procedure used are also shown. The report 410 may also display whether any custom or Z T-codes are used, as can be seen in FIG. 4b.

FIG. 4b shows an example report 420 of custom or Z T-codes which may be used. The report 420 shows that the “Creation of Sales Order” step is not just through the SAP Given Standard T code VA01, but the customer is also creating the sales through Z T-code ZVA01. This information may be used, for example, when asking the customer business reasons for using the customized ZVA01 code instead of the more general question “how do you create a sales order?”

Accordingly, the report provides information on such a granular level which helps the user (e.g., the service provider and/or the customer) better understand the various business process flows configured and being used.

The following examples illustrate correlations which can be identified, for example, between the process flow report and the functionality report. The functionality report displays vast information such as different sales document types, delivery types, billing types, and item categories type used. It also displays the rebates functionality report, intercompany sales report, and route determination report. Billing type F2 is shown used in step 5 as input.

If the user is interested to learn more information on this billing type, for example, “what are the various sales document types associated with billing type F2,” or “how many records are created for F2,” or “is billing type F2 is relevant for rebate,” the user does not have to log into system and spend time figuring all of this out. Instead, the user can check all of this information in the functionality report of the KT tool.

FIGS. 4c and 4d show example functionality reports 430 and 440. Here the list of sales document types associated with billing type F2 are shown. In addition, the user can determine the extent of usage for billing type F2. For example, the F2 billing type is shown having 6054 records created. Hence the user knows that it is important to concentrate on this billing type during the knowledge transition because it has many records. The user can also gain an understanding of issues/tickets that can be expected to be related to billing type F2.

FIG. 4e shows a report illustrating that billing type F2 is relevant for rebates. If the user wants to understand further details, such as a list of customers associated with an active rebate process, the user may run the master data tool to quickly get this information. In this way, the output is correlated (e.g., from process flow to functionalities to master data) to provide a greater understanding of the customer's infrastructure.

Before continuing, it should be noted that the examples described above are provided for purposes of illustration, and are not intended to be limiting. For example, the SAP and ERP environments are merely illustrative and not intended to be limiting. Other operational environments are also contemplated. Other devices and/or device configurations may be utilized to carry out the operations described herein.

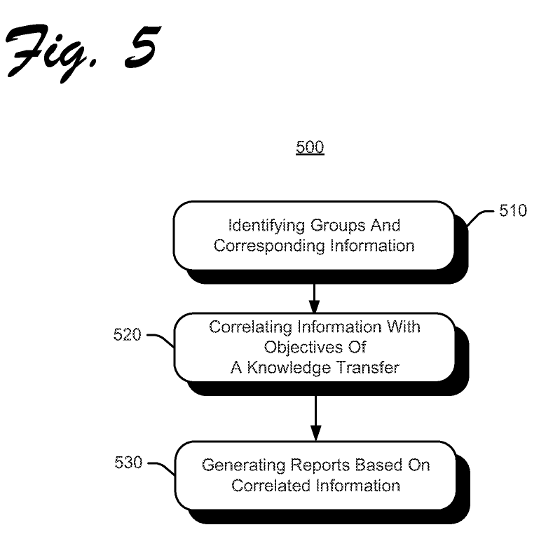

FIG. 5 is a flowchart illustrating example operations which may be implemented for automating provider transitions. Operations 500 may be embodied as logic instructions on one or more non-transient computer-readable medium. When executed on a processor, the logic instructions cause a general purpose computing device to be programmed as a special-purpose machine that implements the described operations. In an example implementation, the components and connections depicted in the figures may be used.

Operation 510 includes identifying groups in an infrastructure. Groups may include, but are not limited to, workgroups, divisions, and project-based groups. These groups may be, for example, sales and distribution, materials managements, financial and control, and project planning. The groups may be further subdivided. For example, the materials management group may be subdivided into an inventory group, and the financial and control group may be subdivided into an accounting group. Other types of groups and/or subgroups are also contemplated.

Operation 520 includes correlating information for each of the groups with predetermined objectives of a knowledge transfer. Correlating information may include, but is not limited to, examining IT infrastructure including hardware and/or software solutions, and functional components within the IT infrastructure (e.g., invoicing modules, and inventory management modules). Other examples of correlating information may include examining IT interconnects, feeds, and output. Still other example information may include IT installation, configuration, upgrade, usage, and operations information. Other types of information for the groups are also contemplated. Transactions and transactional data associated with each of these groups and correlating them and their usage may also be employed.

Operation 530 includes generating reports for each group, the reports providing documentation of existing and proposed customer installations for the infrastructure. Reports may include, but are not limited to, a master data report for the customer installation, process flow reports describing workflow for the customer installation, and function reports describing usage information for the customer installation. Still other reports which may be generated include sales and distribution reports, materials management reports, financial and control reports, and project planning reports. Other types of reports are also contemplated.

It is noted that output reports need not be human readable alone, but can also be machine readable reports in languages like BPML (Business Process Markup Language) so that other software tools can also read the output and interpret the data.

The operations shown and described herein are provided to illustrate various implementations. It is noted that the operations are not limited to the ordering shown. Still other operations may also be implemented.

By way of illustration, operations may also include identifying active functions in the reports for focusing resources only on active functions. Operations may also include identifying custom functions for a particular customer for focusing resources only on custom functions. Standard functions may be ignored for the particular customer. In addition, further functions may be customized for a particular customer based on the reports.

It is noted that in an example, the operations may be implemented at least in part using an end-user interface (e.g., web-based interface). The end-user is able to make predetermined selections, and the operations described above are implemented on a back-end device to present results to a user. The user can then make further selections. It is also noted that various of the operations described herein may be automated or partially automated (e.g., based at least in part on some human input or other interaction). For example, manual knowledge transfer may be used as part of the automated knowledge transfer processes described herein. Typically, any manual knowledge transfer processes may be more focused as a result of having used the automated knowledge transfer tools described herein.

The example embodiments shown and described are provided for purposes of illustration and are not intended to be limiting. Still other embodiments are also contemplated.

1. A method of automating provider transitions, comprising:
identifying groups in an infrastructure and corresponding information for each of the groups;
correlating the information for each of the groups with predetermined objectives of a knowledge transfer; and
generating reports based on the correlated information, the reports providing documentation of customer installations.

2. The method of claim 1 further comprising crawling, mining, identifying, determining usage patterns, correlating and generating a master data report for the customer installation.

3. The method of claim 1 further comprising crawling and mining a customer Enterprise Resource Planning (ERP) installation infrastructure.

4. The method of claim 1 further comprising determining usage patterns for at least customer transactions, history, usage, frequency of use, customizations, activations, variations.

5. The method of claim 1 further comprising generating:
a process flow report describing workflow for the customer installation;
a function report describing usage information for the customer installation; and
a sales and distribution report, a materials management report, a financial and control report, and a project planning report

6. The method of claim 1 further comprising:
identifying active functions in the reports for focusing knowledge transfer resources only on active functions; and
identifying most used functions in the reports for focusing knowledge transfer resources only on the most used functions.

7. The method of claim 1 further comprising identifying custom functions for a particular customer for focusing knowledge transfer resources only on custom functions.

8. The method of claim 7 further comprising ignoring standard functions for the particular customer.

9. The method of claim 1 further comprising customizing transition planning functions for a particular customer based on the reports.

10. An automated provider transitions system comprising:
an input module to identify groups in an infrastructure;
a correlating module to correlate information for each of the groups with predetermined objectives of a knowledge transfer;
a output module to generate documentation of customer installations.

11. The system of claim 10 wherein the documentation is updatable and reusable.

12. The system of claim 10 further comprising a master data report for the customer installation.

13. The system of claim 10 further comprising a process flow report describing workflow for the customer installation.

14. The system of claim 10 further comprising a function report describing usage information for the customer installation.

15. The system of claim 10 further comprising a sales and distribution report, a materials management report, a financial and control report, and a project planning report.

16. The system of claim 10 further comprising a function module to identify active functions for the infrastructure, master data, functionality, and process flow.

17. The system of claim 10 further comprising a function module to identify custom versus standard functions for the infrastructure, master data, functionality, and process flow.

18. The system of claim 10 further comprising a function module to customize functions for the infrastructure, master data, functionality, and process flow, the function module further identifying usage patterns and frequency of use of functions.

19. A system for automating provider transitions, the system having a non-transient computer readable medium to store machine-readable instructions and a processor which executes the machine-readable instructions to:
identify groups in an infrastructure;
correlate information for each of the groups with predetermined objectives of a knowledge transfer; and
generate documentation of customer installations.

20. The system of claim 10 wherein the documentation provides instruction for efficient knowledge transfer between a departing service provider and a proposed incoming service provider, the documentation including both human readable and machine readable documentation.
